(19) United States
(12) Patent Application Publication
(10) Pub. No.: US 2010/0008838 A1
(43) Pub. Date: Jan. 14, 2010

(54) METHODS AND APPARATUS FOR ABATING ELECTRONIC DEVICE MANUFACTURING PROCESS EFFLUENT

(75) Inventors: Allen Fox, Sunnyvale, CA (US); Daniel O. Clark, Pleasanton, CA (US); Frank F. Hooshdaran, Pleasanton, CA (US); Belynda Flippo, Capitola, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/500,257

(22) Filed: Jul. 9, 2009

Related U.S. Application Data
(60) Provisional application No. 61/080,105, filed on Jul. 11, 2008.

(51) Int. Cl. B01D 53/68; B01D 53/00; G05D 7/00

(52) U.S. Cl. 423/240 R; 422/172; 422/111

(57) ABSTRACT

A thermal abatement system is provided, including: a thermal abatement reactor; an inlet in fluid communication with the reactor; a process chamber in fluid communication with the inlet; a first sheathing fluid source in fluid communication with the inlet; a first flow control device, adapted to regulate a flow of a first sheathing fluid from the first sheathing fluid source; and a controller, in signal communication with the first flow control device, adapted to regulate the sheathing fluid by operating the first flow control device; wherein the inlet is adapted to receive an effluent stream from the process chamber and the first sheathing fluid from the first sheathing fluid source, to sheathe the effluent stream with the first sheathing fluid to form a sheathed effluent stream, and to introduce the sheathed effluent stream into the reactor.

The present application claims priority to U.S. Provisional Patent Application Ser. No. 61/080,105, filed Jul. 11, 2008 and entitled “METHODS AND APPARATUS FOR MOVING A REACTION FURTHER INTO A REACTOR” (Attorney Docket No. 11627/L), which is hereby incorporated herein by reference in its entirety for all purposes.

### CROSS-REFERENCE TO RELATED APPLICATION

The present application is related to the following commonly-assigned, co-pending U.S. Patent Application, which is hereby incorporated herein by reference in its entirety for all purposes:

U.S. patent application Ser. No. 10/987,921 filed on Nov. 12, 2004, and entitled “REACTOR DESIGN TO REDUCE PARTICLE DEPOSITION DURING PROCESS ABATEMENT.” (Attorney Docket No. 9985)

U.S. patent application Ser. No. 08/775,838, filed Dec. 31, 1996, now U.S. Pat. No. 5,955,037 and entitled “EFFLUENT GAS STREAM TREATMENT SYSTEM HAVING UTILITY FOR OXIDATION TREATMENT OF SEMICONDUCTOR MANUFACTURING EFFLUENT GASES.” (Attorney Docket No. 9955).

U.S. patent application Ser. No. 09/400,662, filed Sep. 20, 1999, now U.S. Pat. No. 6,333,010 and entitled “EFFLUENT GAS STREAM TREATMENT SYSTEM HAVING UTILITY FOR OXIDATION TREATMENT OF SEMICONDUCTOR MANUFACTURING EFFLUENT GASES.” (Attorney Docket No. 9955/C01).

U.S. patent application Ser. No. 09/307,058, filed May 7, 1999, now U.S. Pat. No. 6,322,756, and entitled “EFFLUENT GAS STREAM TREATMENT SYSTEM HAVING UTILITY FOR OXIDATION TREATMENT OF SEMICONDUCTOR MANUFACTURING EFFLUENT GASES.” (Attorney Docket No. 9955/P01).

U.S. patent application Ser. No. 11/745,428, filed May 7, 2007, and entitled “EFFLUENT GAS STREAM TREATMENT SYSTEM HAVING UTILITY FOR OXIDATION TREATMENT OF SEMICONDUCTOR MANUFACTURING EFFLUENT GASES.” (Attorney Docket No. 9955/D02).

U.S. patent application Ser. No. 09/970,613, filed Oct. 4, 2001, now U.S. Pat. No. 7,214,349, and entitled “EFFLUENT GAS STREAM TREATMENT SYSTEM HAVING UTILITY FOR OXIDATION TREATMENT OF SEMICONDUCTOR MANUFACTURING EFFLUENT GASES.” (Attorney Docket No. 9955/D01/Y02).

U.S. patent application Ser. No. 11/552,447, filed Oct. 24, 2006, and entitled “EFFLUENT GAS STREAM TREATMENT SYSTEM HAVING UTILITY FOR OXIDATION TREATMENT OF SEMICONDUCTOR MANUFACTURING EFFLUENT GASES.” (Attorney Docket No. 9955/D01/C02/Y01).

U.S. patent application Ser. No. 11/838,549, filed Aug. 14, 2007, and entitled “EFFLUENT GAS STREAM TREATMENT SYSTEM HAVING UTILITY FOR OXIDATION TREATMENT OF SEMICONDUCTOR MANUFACTURING EFFLUENT GASES.” (Attorney Docket No. 9955/D01/C03).

U.S. patent application Ser. No. 09/420,080, filed Oct. 18, 1999, now U.S. Pat. No. 6,423,284, and entitled “FLUORINE ABATEMENT USING STEAM INJECTION OXIDATION TREATMENT OF SEMICONDUCTOR MANUFACTURING EFFLUENT GASES.” (Attorney Docket No. 9969).

U.S. patent application Ser. No. 10/150,468, filed May 17, 2002, and entitled “FLUORINE ABATEMENT USING STEAM INJECTION OXIDATION TREATMENT OF SEMICONDUCTOR MANUFACTURING EFFLUENT GASES.” (Attorney Docket No. 9969/D01).

### FIELD OF THE INVENTION

The present invention relates to abatement systems used in electronic device, semiconductor, solar, LCD, film, OLED, and nano manufacturing, and more particularly to methods and apparatus for introducing fluids into an abatement reactor.

### BACKGROUND OF THE INVENTION

Effluent gases from the manufacturing of semiconductor, solar, LCD, film, OLED, and nanomanufacturing materials, and electronic devices, products and memory articles are made up of a wide variety of chemical compounds used and produced in a manufacturing facility. These compounds include inorganic and organic compounds, breakdown products of photo-resist and other reagents, and a wide variety of other gases. These gases are desirable to be removed from the effluent gas before being vented from the process facility into the atmosphere.

A significant problem within the aforementioned manufacturing industries has been the removal of these materials from the effluent gas streams. While virtually all U.S. electronic device and semiconductor, solar, LCD, film, OLED, and nano manufacturing facilities utilize scrubbers or similar means for treatment of such effluent gases, scrubbing technology alone may not be capable of removing all toxic or otherwise unacceptable impurities.

One solution to this problem is to incinerate or combust the effluent gas to oxidize the toxic materials thereby converting them into less toxic forms. In conventional systems, air, oxygen or oxygen-enriched air may be added directly into the combustion chamber of a reactor for mixing with the effluent gas to promote combustion and aid in the conversion of toxic materials to less toxic form.

Accordingly, methods and apparatus for introducing gaseous effluent components into the reactor chamber of an abatement system are desired.

### SUMMARY OF THE INVENTION

In one aspect of the present invention, a thermal abatement system is provided, including: a thermal abatement reactor; an inlet in fluid communication with the reactor; a process chamber in fluid communication with the inlet; a first sheathing fluid source in fluid communication with the inlet; a first flow control device, adapted to regulate a flow of a first sheathing fluid from the first sheathing fluid source; and a controller, in signal communication with the first flow control device, adapted to regulate the sheathing fluid by operating the first flow control device; wherein the inlet is adapted to receive an effluent stream from the process chamber and the first sheathing fluid from the first sheathing fluid source, to sheathe the effluent stream with the first sheathing fluid to form a sheathed effluent stream, and to introduce the sheathed effluent stream into the reactor.

In another aspect of the present invention, a method for operating a thermal abatement system is provided, including: receiving an effluent stream into an inlet; receiving a first sheathing fluid into the inlet; forming a sheath of the first sheathing fluid around the effluent stream to form a sheathed effluent stream; introducing the sheathed effluent stream from the inlet into a thermal reactor; regulating the first sheathing fluid using a controller; and abating a portion of the effluent stream in the thermal reactor.

In yet another aspect of the present invention, A method for operating a thermal abatement system is provided, including: determining one or more of a chemistry and a flow rate of an effluent stream; selecting a sheathing fluid based on one or more of the chemistry and the flow rate of the effluent stream; supplying the selected sheathing fluid to an inlet by operating at least one flow control device to regulate the flow of at least one sheathing fluid; receiving the effluent into an inlet; forming a sheath of the sheathing fluid around the effluent stream to form a sheathed effluent stream; introducing the sheathed effluent stream from the inlet into a thermal reactor; and abating a portion of the effluent stream in the thermal reactor.

Other features and aspects of the present invention will become more fully apparent from the following detailed description, the appended claims and the accompanying drawings.

### BRIEF DESCRIPTION OF THE FIGURES

FIG. 1 is a schematic diagram of an abatement system (or a portion thereof) in accordance with embodiments of the present invention.

FIG. 2 is a planar schematic illustration of an inlet according to the prior art.

FIG. 3 is a planar schematic illustration of gas flow lines around an inlet according to the prior art.

FIG. 4A is a cross-sectional view of a gas inlet apparatus in accordance with an embodiment of the present invention.

FIG. 4B is a cross-sectional view of the gas inlet apparatus of FIG. 4A taken along section line 4B-4B.

FIG. 4C is a planar schematic illustration of gas flow lines around an inlet according to embodiments of the present invention.

FIG. 5 is a schematic illustration of a bottom of an inlet assembly in accordance with an embodiment of the present invention.

FIG. 6 is a flowchart depicting an exemplary method of the present invention.

FIG. 7 is a flowchart depicting another exemplary method of the present invention.

FIG. 8 is a flowchart depicting yet another exemplary method of the present invention.

### DETAILED DESCRIPTION

The introduction of air, oxygen or oxygen-enriched gas may cause certain unwanted reactions within a reaction chamber. For example, during the introduction of oxygen into a combustion chamber of an abatement unit, certain reactions may take place between the effluent components (e.g., silane) and oxygen (in air or oxygen-enriched air for example) supplied to the reaction chamber. As a result of these reactions, oxides, for example, silicon oxides, may be formed and these oxides may be deposited on the walls of the reaction chamber. In some instances, such deposits may form in or quite near the inlet to the reaction chamber. A mass of silicon oxides formed may be relatively large and the gradual deposition within or near the inlet to the reaction chamber may induce poor combustion and/or may cause clogging of the reaction chamber inlet, thereby necessitating increased maintenance of the reactor. Depending on the circumstances, cleaning of the abatement unit may need to be performed quite often, even as frequently as every three days.

The present invention provides systems, apparatus and methods for eliminating or reducing a severity of such deposits at or near the gas inlet (e.g., the effluent gas inlet) of the reaction chamber. In particular, the present invention may allow the reaction to be moved further into the reactor chamber and away from the gas inlet. The present invention may provide a curtain of a fluid (e.g., nitrogen) proximate the gas inlet to the reaction chamber such that introduced effluent gases do not react with the oxygen or oxygen-enriched air until further into the reactor chamber, and away from the inlet of the reaction chamber. Accordingly, the inlet may be less prone to becoming clogged with the reaction products from the reaction.

In addition, the present invention provides systems, apparatus and methods for enhancing the abatement of various effluents. In particular, the present invention may enhance the abatement of effluent by providing a curtain of a reagent fluid proximate the gas inlet to the reaction chamber such that introduced effluent gases may react with or be catalyzed by the reagent fluid. As such, the effluent may be more effectively abated.

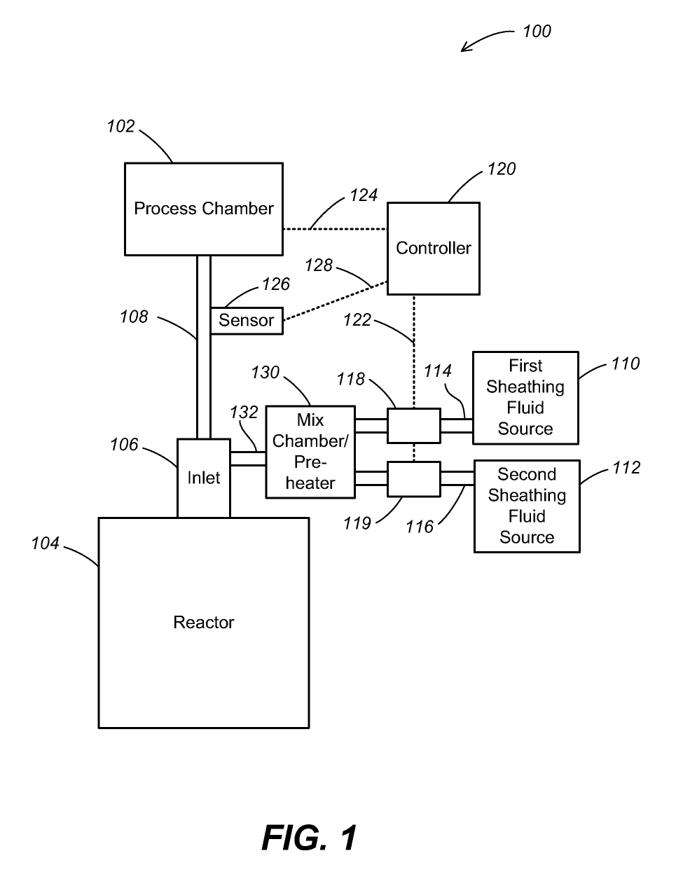

Turning to FIG. 1 of the present invention, a system 100 is provided. Although only one process chamber 102, one inlet 106 and one abatement reactor 104 are shown, the system 100 may include one or more process chambers 102 coupled to one or more reactors 104 of an abatement system 100 via one or more inlet assemblies 106, which may allow fluid communication between the process chamber 102 and the reactor 104.

The process chambers 102 may include, for example, chemical vapor deposition chambers, physical vapor deposition chambers, chemical mechanical polishing chambers, etc. The processes that may be performed in the chambers include, for example, diffusion, PFC etch and epitaxy. Byproduct chemicals to be abated from these processes may include, for example, hydrides of antimony, arsenic, boron, germanium, nitrogen, phosphorous, silicon, selenium, silane, silane mixtures with phosphine, argon, hydrogen, organosilanes, halosilanes, halogens, organometallics and other organic compounds. The halogens, e.g., fluorine (F₂) and other fluorinated compounds, are particularly problematic among the various components requiring abatement. The electronics industry frequently uses perfluorinated compounds (PFCs) in substrate processing tools to remove residue from deposition steps and to etch thin films. Examples of some of the most commonly used PFCs include CF₄, C₂F₆, SF₆, C₃F₈, C₄F₈, C₄F₈O, NF₃, CHF₃, CH₃F, CH₂F₂.

A channel 108 (e.g., an exhaust conduit) may extend from each process chamber 102 to allow a flow of one or more effluent gases to exit the process chamber 102. The effluent gases may flow from the process chamber 102 through the channel 108 and into the inlet assembly 106.

The inlet assembly 106 may include one or more openings or inlets or other channels for the reception of effluent gas exhausted from the one or more chambers in processing tools 102. Additionally, the inlet assembly 106 may include one or more openings for receiving a flow of so-called “sheathing fluids” (e.g., oxygen, hydrogen, nitrogen, CDA, methane, etc.) from one or more sheathing fluid sources, such as first sheathing fluid source 110, and second sheathing fluid source 112, into the reactor 104 through conduits 114, 116. The inlet assembly 106 may include 1, 2, 3, . . . , n inlets or openings for such sheathing fluids. As described in more detail below, the inlet may be adapted to sheath an effluent stream with a sheathing gas to form a sheathed effluent stream which may be introduced into the abatement reactor 104.

A controller 120 may be connected to flow control devices 118, 119 through signal lines 122, to the process chamber 102 through signal line 124, and to sensor 126 through signal line 128. The signal lines 122, 124 and 128 may be hardwired connections or may be wireless connections. Although sensors 126 are shown in sensing communication with conduit 108, it should be understood that sensors may also be positioned to sense properties or conditions within the abatement reactor 104, the process chamber 102, or in any other suitable location.

Flow control devices 118, 119 may be valves, pumps, mass flow controllers or any other suitable flow control devices, and may be connected to mixing chamber 130 through conduits 114, 116 and from mixing chamber 130 to inlet 106 through conduit 132. It should be noted that although two flow control devices 118, 119 are shown, fewer or more flow control devices 118, 119 may be used, e.g., 1, 3, 4, 5, or more. The mixing chamber 130 is optional, and may be replaced with a simple y-shaped or other shaped junction of conduits 114, 116. In an alternative embodiment, the mixing chamber 130 may be replaced with or combined with an sheathing fluid pre-heater 130.

The controller 120 may be adapted to regulate the total flow and the flow ratio of one or more sheathing fluids from first and second sheathing fluid sources 110, 112, for example, by operating flow control devices 118, 119. By operating the sheathing fluid sources independently of each other, the controller 120 may be able to regulate the chemistry of a combined sheathing fluid which results from mixing the sheathing fluids. The controller 120 may be able to receive information from several sources. For example, the controller 120 may receive information from the process chamber 102 regarding the process step or steps which are being executed and may be adapted to use this information as a basis for controlling the flow of sheathing fluids. In addition to receiving information from the process chamber 102, the controller 120 may be adapted to receive information from one or more sensors 126, such as a nature of the effluent which is flowing through conduit 108 and/or the flow rate of effluent which is flowing through conduit 108. Thus, sensors 126 may be one or more of a flow sensor, and composition sensor, such as a thermopile detector. As stated above, sensors 126 may also be located in additional locations such as the abatement reactor 104, and/or the process chamber 102. Once again, the controller may use such sensor information as a basis for controlling the flow of sheathing fluids, as described in more detail below.

In some embodiments, the controller 120 may be coupled to and/or otherwise communicate with and/or control operation of the process chamber 102 and abatement systems. The controller 120 may be a microcomputer, microprocessor, logic circuit, a combination of hardware and software, or the like. The controller 120 may include various communications facilities including input/output ports, a keyboard, a mouse, a display, a network adapter, etc.

Typically, processing operations associated with electronic device manufacturing produce effluent gas that may include, for example, one or more of silane, H₂, fluorine, silicon tetrafluoride (SiF₄), hydrogen fluoride (HF), carbonyl fluoride (COF₂), CF₄ and C₂F₆. As described above, abatement systems may include one or more reactors 104 for the treatment of certain components in the effluent gases (e.g., a combustion reactor for combusting flammable or pyrophoric components such as silane and H₂). In addition, for example, abatement systems may employ additional wet scrubbing, dry scrubbing, catalytic, plasma and/or similar means for converting the combusted effluent gases from the reactor to less toxic forms.

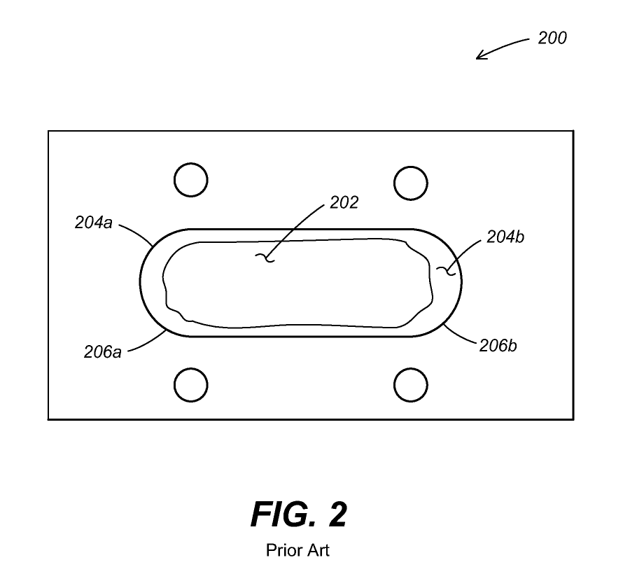

Turning to FIG. 2, a planar view of an exemplary inlet assembly 200 of the prior art having an inlet 202 is depicted. As shown therein, the inlet 202 may have deposits forming clogged portions 204a, 204b. In some cases, the clogging may occur on the edges 206a, 206b of the inlet 202. As noted above, the clogging may occur as a result of the effluent, which may contain silane and hydrogen, for example, and the oxygen, which may be added during combustion to convert the effluent to a less toxic species, for example, reacting in the inlet 202 as opposed to reacting within the chamber of the reactor 104 (FIG. 1). This reaction may result in a buildup of matter (e.g., silicon dioxide) in the inlet 202, which may eventually partially or significantly clog the inlet 202.

As the inlet 202 becomes clogged, the pressure within the inlet 202 may increase. In some instances, the pressure may increase to a point at which an alarm indicator (not shown) may be activated, which may commence a shut-down process. This may result in the inlet 202 needing to be cleaned.

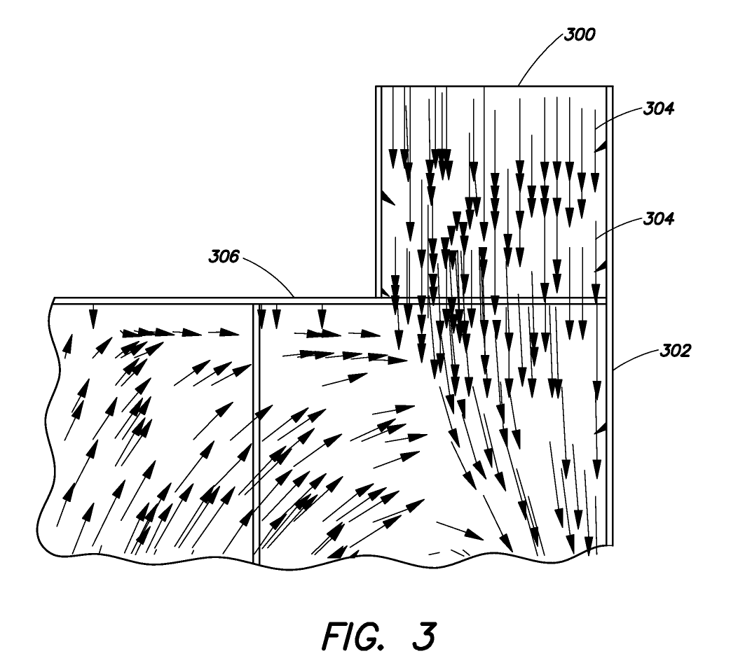

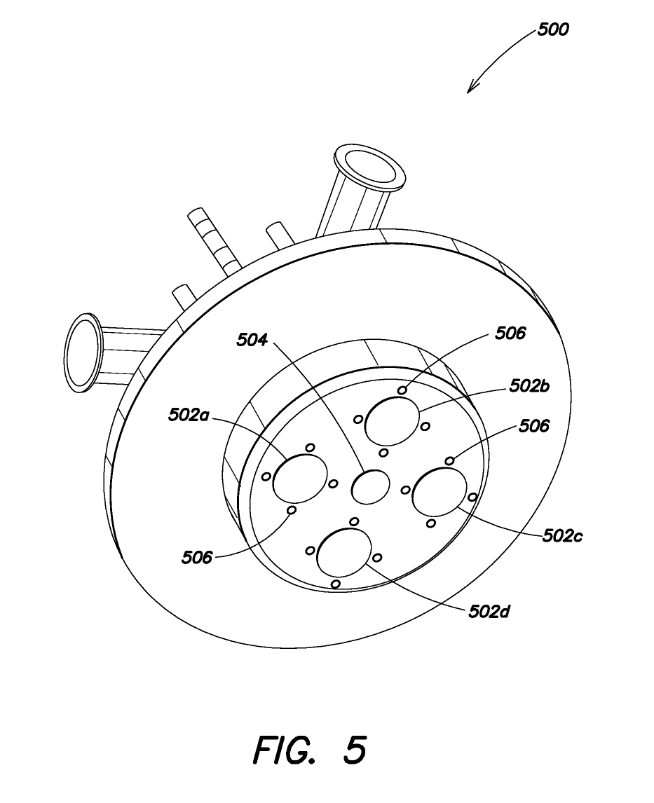

Turning to FIG. 3, a planar schematic view of an inlet 300 coupled to a reactor 302 according to the prior art is depicted. The effluent may flow through the inlet 300 to a chamber of the reactor 302, as indicated by the downward facing directional arrows 304. As described above, the walls (herein located at a top plate 306) of the reactor 302 may be porous and allow the diffusion of oxygen into the reactor 302, but also into the inlet, by flowing around the corner of top plate 306 and in a countercurrent direction into the inlet 300, for example. The reactor 302 may include fuel gas jets (shown in FIG. 5) adapted to produce flames, and hence heat which may be used to convert a toxic effluent into less toxic forms. In some instances, an eddy current may pull oxygen into the reactor 302 and under the inlet 300, as indicated by the right-horizontal facing directional arrows in FIG. 3. Some oxygen may even be pulled into the inlet 300. In the prior art system, the combustion in/near the inlet 300 of the effluent, combined with the oxygen diffusion into the corners of the inlet 300, may lead to a premature silane reaction within the inlet 300 (on the walls or edges) rather than in the reactor 302. As described above, this reaction may result in a buildup of silicon dioxide in the inlet 300, which may eventually reduce the flow in, or clog, the inlet 300.

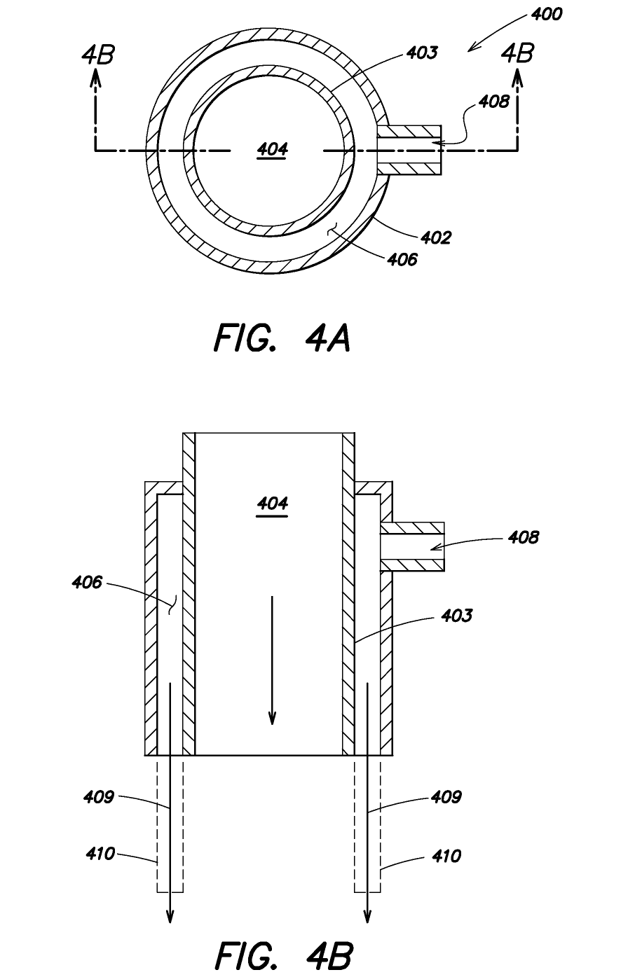

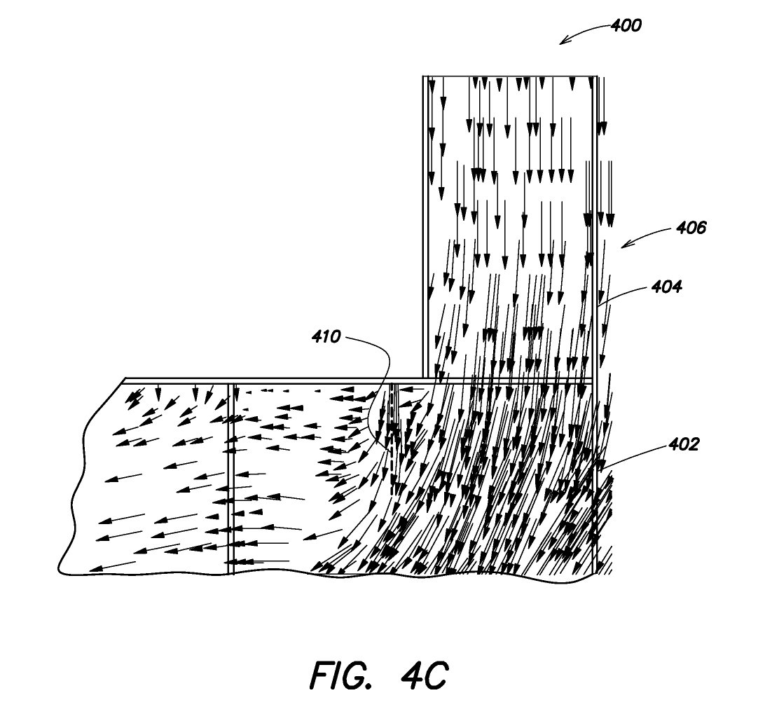

Turning to FIG. 4A, a schematic cross-sectional view of an exemplary gas inlet apparatus 400 of the invention is depicted. The gas inlet apparatus 400 may include an outer sleeve 402 that surrounds an inner sleeve 403. Inner sleeve 403 may form an effluent passage 404. Although, outer sleeve 402 is depicted as a separate member, outer sleeve 402 may be machined, or otherwise formed, in a block of material such as a top member of an abatement reactor. The outer and inner sleeves 402, 403 may be round or any other suitable shape. The space between the outer sleeve 402 and the inner sleeve 403 may be referred to as a gap, or an annular gap 406, through which a sheathing fluid (e.g., nitrogen, argon, hydrogen, methane, or mixture thereof, etc.) may be flowed. For purposes of discussion, nitrogen will represent a sheathing fluid. However, other fluids may be used. The annular gap 406 may be, for example, about 2 mm wide. Other gap widths may be used. Also, other shapes such as oval, etc. may be used.

As shown in FIGS. 4A and 4B, the nitrogen may flow into the annular gap 406 formed between the inner sleeve 403 and the outer sleeve 402 through an inlet port 408 from a gas source (such as shown in FIG. 1). In operation, as the nitrogen flows out of the annular gap 406 as indicated by arrows 409, an annular curtain or shroud of nitrogen may form around the effluent passage 404. The curtain is indicated by dotted line 410. The nitrogen may be flowed, for example, at about 20 slm. Other flow rates may be used, depending upon the flow rate of effluent stream through the effluent passage 404. The curtain of nitrogen may prevent diffusion or flow of oxygen into the effluent passage 404. Thus, the nitrogen curtain 410 may prevent the oxygen from reacting with the effluent gas flowing through effluent passage 404 until a location further (deeper) into the reactor (not shown) and away from the effluent passage 404 (i.e., remote from the effluent passage 404). Because the oxygen may not diffuse or flow into the effluent passage 404, buildup of silicon dioxide in the effluent passage 404 may be reduced or eliminated. Accordingly, a time between inlet cleanings may increase substantially, for example. A depiction of the flow resulting from the provision of the sheathing fluid curtain 410 is illustrated in FIG. 4C. FIG. 4C illustrates that the curtain 410 provided proximate to the exit from the effluent passage 404 may minimize flow and diffusion of oxygen from the reactor 402 into the effluent passage 404.

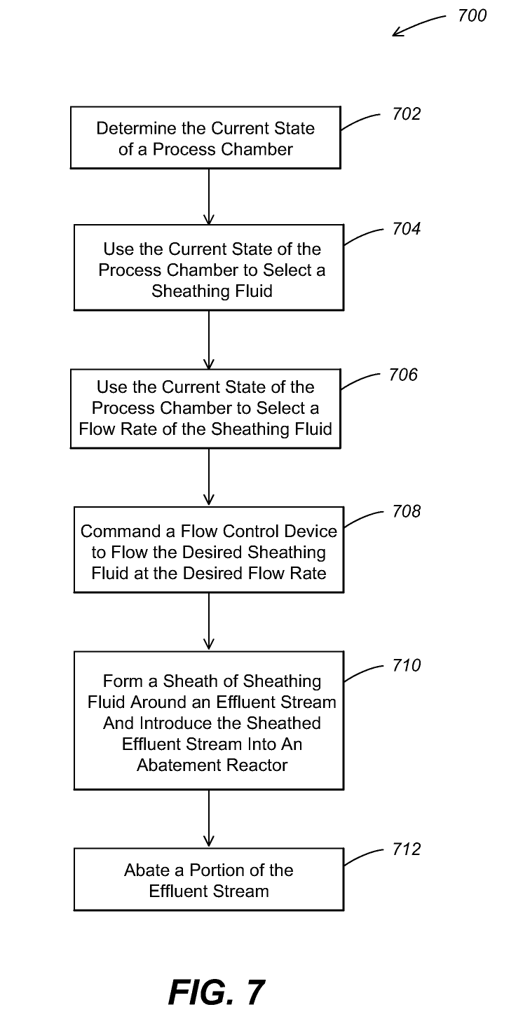

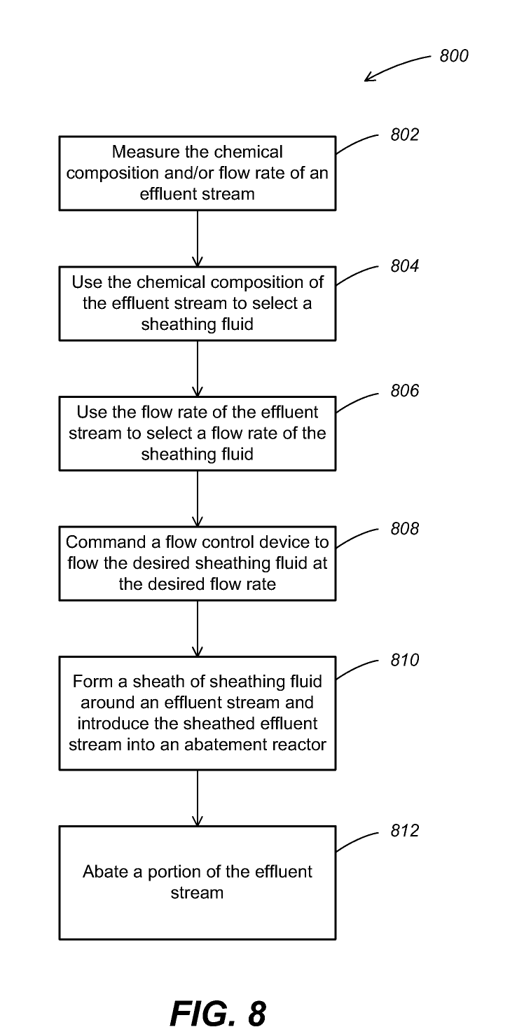

Turning to FIG. 5, a schematic illustration of a bottom view of an exemplary embodiment of an inlet assembly 500 is depicted. Herein, the inlet assembly 500 may include multiple inlets 502a, 502b, 502c and 502d. As described above, the inlet assembly 500 may include 1, 2, 3, . . . , n inlets or openings. Multiple inlets may allow, for example, the passage of effluent gas from different processing chambers 102 of one or more processing tools (not shown) to the reactor 104. A pilot light 504 may be positioned, for example, in the middle of the inlets 502a-d and adapted to ignite the fuel flowing from fuel gas jets 506 surrounding each inlet 502a-d. The flames from the fuel gas jets 506 may produce heat which may be used to decompose or ignite the effluent gases to form less noxious gases or byproducts during the abatement processes. Each of the multiple inlets 502a-d may include an annular curtain of inert gas surrounding the inlet. Each of the multiple inlets 502a-d may be independently controlled, as described below with respect to FIGS. 7 and 8. This curtain may be provided by an inlet structure such as described in FIGS. 4A and 4B, for example.

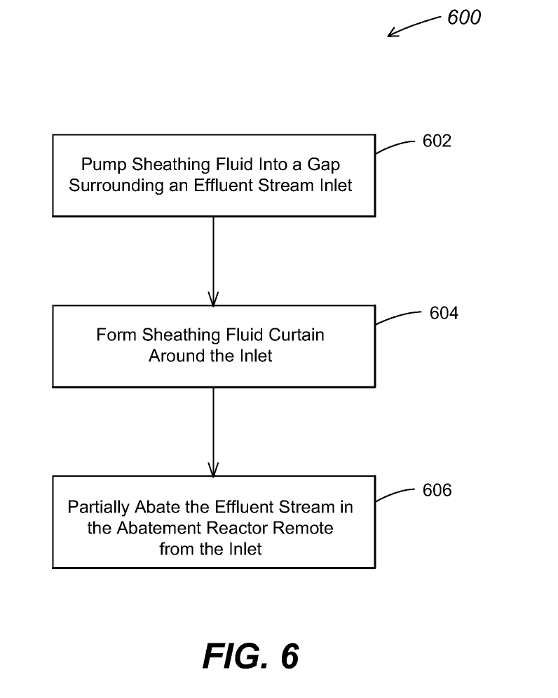

Turning to FIG. 6, a flowchart illustrating an exemplary method 600 of the present invention is depicted. In step 602, a sheathing fluid, such as, for example, an inert gas (e.g., N₂ gas) is pumped into a gap (e.g., an annular gap) proximate to and surrounding an effluent stream passage. The sheathing fluid flows into a reactor chamber and forms a sheathing fluid annular curtain (or sheath) around an exit of the inlet into the reactor chamber. The curtain may prevent or minimize oxygen from entering into the inlet in step 604. The curtain may cause the reaction with the effluent stream to occur further into the reactor chamber in step 606 and at a position remote from the inlet. As a consequence, fewer deposits (e.g., SiO₂) may be formed on the inlet walls or edges. Accordingly, the inlet may be cleaned less regularly as it may take a longer time for the inlet to get clogged when the oxygen is reacting with the effluent stream further into the reactor, as opposed to directly adjacent to, or in, the inlet. If a reagent sheathing fluid is used, the curtain may enhance the abatement reaction.

Turning to FIG. 7, a flowchart illustrating an exemplary method 700 of the present invention is depicted. In step 702, the current state of a process chamber is determined. By current state is meant the nature of the process being conducted in the chamber, such as, for example, deposition or clean, etc. In addition, to a process, the current state may include the process chamber being idle or down, such as for preventive maintenance or other reason.

The current state of the process chamber may be communicated from the process chamber 102, or from a separate process chamber controller (not shown), to the controller 120. Alternatively, the controller 120 may also serve as a process controller, and may contain, or have access to, a schedule of processes to be conducted in each process chamber 102. In such a case, determining the current state of the process chamber may be accomplished by polling a database which may be contained within or without the controller 120. In addition, the current state of the process chamber may be inferred from knowing the state of a gas panel (not shown)which provides reagents to the process chamber 102. Thus, the gas panel (not shown) may be in signal connection with the controller 120. Once the process state is known, the nature (chemical composition) and flow rate of the effluent stream is known.

In step 704, the current state of the process chamber 102, determined in step 702, is used to select a sheathing fluid or, in the case where the process chamber 102 is down, no sheathing fluid at all. For example, it may be desired to flow an inert gas during abatement of a deposition process effluent stream, or during a cleaning process effluent stream. Alternatively, it may be desired to flow one or more reagents, or a mixture of one or more reagents and an inert gas, during abatement of a particular deposition effluent stream, or during abatement of a cleaning process effluent stream. Which sheathing fluid to flow may be determined by the operator of the abatement system, e.g., in advance, and can be programmed into the controller 120.

In step 706, the current state of the process chamber 102, determined in step 702, is used to select a flow rate for the sheathing fluid. Once the current state of the process chamber 102 is known, the flow rate of the effluent stream is known. For example, if the process chamber 102 is down, a zero flow may be selected. If a process is occurring in the process chamber 102, it may be desirable to match the velocity and/or viscosity of the sheathing fluid to the velocity and/or viscosity of the effluent stream in order to achieve laminar flow and/or to reduce turbulence in the sheathed effluent stream. Thus, the flow rate for the one or more sheathing fluids may be selected so that the velocity and/or viscosity of the one or more sheathing fluids matches the velocity and/or viscosity of the effluent stream.

In step 708, one or more flow control devices are commanded to flow the desired sheathing fluid or fluids at the desired flow rate(s). The command may be issued by the controller 120 to the one or more flow control devices 118, 119. Thus, the chemistry of the sheathing fluid may be selected or controlled by appropriately commanding flow ratios between first and second (or more) sheathing fluids, and the overall flow rate of the desired combined or single sheathing fluid may be selected by commanding appropriate magnitudes for the flow rates of the one or more sheathing fluids. The sheathing fluids may optionally be pre-heated.

In step 710, a sheath of sheathing fluid is formed around the effluent stream, and the sheathed effluent stream is introduced into the abatement reactor. The sheath may be formed using the structures and methods described above with respect to FIGS. 3-6.

In step 712, a portion of the effluent stream is abated in the abatement reactor using conventional abatement techniques or yet to be discovered abatement techniques.

Turning to FIG. 8, a flowchart illustrating an exemplary method 800 of the present invention is depicted. Method 800 is substantially similar to method 700, but with the following differences. In step 802, rather than determining the current state of a process chamber 102, as in step 702, the chemical composition and/or the flow rate of an effluent stream are measured using one or more sensors 126. The chemical composition and/or flow rate of the effluent stream are then transmitted to the controller 120.

In step 804, if chemical composition has been measured in step 802, the chemical composition may be used to select one or more sheathing fluids. One of ordinary skill in the art would be able to program the controller to select appropriate sheathing fluids based upon the chemical composition of the effluent stream. Step 804 is analogous to step 704, discussed above.

In step 806, if effluent stream flow rate has been measured is step 802, the flow rate may be used to select an appropriate sheathing fluid flow rate to achieve a desired laminar flow. Step 806 is analogous to step 706, discussed above.

In step 808, one or more flow control devices are commanded to flow the desired sheathing fluid or fluids at the desired flow rate(s). The discussion above of step 708 is equally applicable to step 808.

In step 810, a sheath of sheathing fluid is formed around the effluent stream, and the sheathed effluent stream is introduced into the abatement reactor. The sheath may be formed using the structures and methods described above with respect to FIGS. 3-6.

In step 812, a portion of the effluent stream is abated in the abatement reactor.

The foregoing description discloses only exemplary embodiments of the invention. Modifications of the above disclosed apparatus and methods which fall within the scope of the invention will be readily apparent to those of ordinary skill in the art. In some embodiments, the apparatus and methods of the present invention may be applied to semiconductor, solar, LCD, film, OLED, and nanomanufacturing materials and device processing and/or electronic device manufacturing.

Accordingly, while the present invention has been disclosed in connection with exemplary embodiments thereof, it should be understood that other embodiments may fall within the spirit and scope of the invention, as defined by the following claims.

The invention claimed is:

1. A thermal abatement system comprising:
a thermal abatement reactor;
an inlet in fluid communication with the reactor;
a process chamber in fluid communication with the inlet;
a first sheathing fluid source in fluid communication with the inlet;
a first flow control device, adapted to regulate a flow of a first sheathing fluid from the first sheathing fluid source; and
a controller, in signal communication with the first flow control device, adapted to regulate the sheathing fluid by operating the first flow control device;
wherein the inlet is adapted to receive an effluent stream from the process chamber and the first sheathing fluid from the first sheathing fluid source, to sheathe the effluent stream with the first sheathing fluid to form a sheathed effluent stream, and to introduce the sheathed effluent stream into the reactor.

2. The thermal abatement system of claim 1, wherein the controller is adapted to regulate the velocity of the sheathing fluid by operating the first flow control device.

3. The thermal abatement system of claim 1, wherein the controller is adapted to regulate the flow rate of the sheathing fluid by operating the first flow control device.

4. The thermal abatement system of claim 3, further comprising a flow sensor in sensing communication with an effluent stream conduit and adapted to measure a flow rate of the effluent stream from the process chamber to the reactor, wherein the controller is adapted to receive a signal from the flow sensor and to regulate the flow of the sheathing fluid based upon the flow rate of the effluent stream.

5. The thermal abatement system of claim 1, further comprising a second sheathing fluid source in fluid communication with the inlet, wherein the inlet is further adapted to receive the first and second sheathing fluids from the first and the second sheathing fluid sources.

6. The thermal abatement system of claim 5, further comprising:
a second flow control device, adapted to control a flow of the second sheathing fluid, and
a mixing device, in fluid communication with the first and second sheathing fluid sources and with the inlet, and adapted to combine the first sheathing fluid with the second sheathing fluid to form a combined sheathing fluid;
wherein the controller is adapted to regulate a chemistry of the combined sheathing fluid by operating the first and second flow control devices.

7. The thermal abatement system of claim 1, wherein the controller is further adapted to maintain a laminar flow of the sheathed effluent stream.

8. The thermal abatement system of claim 1, wherein the controller is further adapted to reduce turbulence in the sheathed effluent stream.

9. The thermal abatement system of claim 1, wherein the controller is further adapted to modify the viscosity of the sheathing fluid.

10. The thermal abatement system of claim 1, further comprising a sheathing fluid pre-heater.

11. A method for operating a thermal abatement system, comprising:
receiving an effluent stream into an inlet;
receiving a first sheathing fluid into the inlet;
forming a sheath of the first sheathing fluid around the effluent stream to form a sheathed effluent stream;
introducing the sheathed effluent stream from the inlet into a thermal reactor;
regulating the first sheathing fluid using a controller; and
abating a portion of the effluent stream in the thermal reactor.

12. The method for operating a thermal abatement system of claim 11, wherein the first sheathing fluid comprises an inert fluid.

13. The method for operating a thermal abatement system of claim 11, wherein the first sheathing fluid comprises a reagent.

14. The method for operating a thermal abatement system of claim 12, wherein the first sheathing fluid further comprises a reagent.

15. The method for operating a thermal abatement system of claim 11, further comprising receiving a second sheathing fluid into the inlet.

16. The method for operating a thermal abatement system of claim 11, wherein regulating the first sheathing fluid comprises regulating the flow rate of the sheathing fluid.

17. The method for operating a thermal abatement system of claim 11, wherein regulating the first sheathing fluid comprises regulating the chemistry of the sheathing fluid.

18. The method for operating a thermal abatement system of claim 11, wherein the first sheathing fluid is preheated.

19. The method for operating a thermal abatement system of claim 11, further comprising reducing turbulence in the sheathed effluent stream.

20. A method for operating a thermal abatement system, comprising:
determining one or more of a chemistry and a flow rate of an effluent stream;
selecting a sheathing fluid based on one or more of the chemistry and the flow rate of the effluent stream;
supplying the selected sheathing fluid to an inlet by operating at least one flow control device to regulate the flow of at least one sheathing fluid;
receiving the effluent into an inlet;
forming a sheath of the sheathing fluid around the effluent stream to form a sheathed effluent stream;
introducing the sheathed effluent stream from the inlet into a thermal reactor; and
abating a portion of the effluent stream in the thermal reactor.

21. The method for operating a thermal abatement system of claim 20, wherein the chemistry of the effluent stream is determined.

22. The method for operating a thermal abatement system of claim 20, wherein the flow rate of the effluent stream is determined.

23. The method for operating a thermal abatement system of claim 20, wherein the chemistry and flow rate of an effluent stream is inferred from the state of a gas panel which supplies reagents to a process chamber.
